(19) United States
(12) Patent Application Publication
(10) Pub. No.: US 2014/0279363 A1
(43) Pub. Date: Sep. 18, 2014

(54) METHOD OF INTERACTING WITH POSITION ANALYSIS AND DEVICE FOR DISPLAYING INFORMATION WITH REGARD TO SAME

(71) Applicant: MOLECULE SOFTWARE, INC., Houston, TX (US)

(72) Inventors: Randall S. BAKER, Houston, TX (US); Adam G. STRICKLAND, Houston, TX (US); Sameer SOLEJA, Houston, TX (US); Adam SUNDERLAND, Houston, TX (US); Hana Z. WANG, Houston, TX (US)

(73) Assignee: MOLECULE SOFTWARE, INC., Houston, TX (US)

(21) Appl. No.: 14/213,722

(22) Filed: Mar. 14, 2014

Related U.S. Application Data
(60) Provisional application No. 61/788,003, filed on Mar. 15, 2013.
(60) Provisional application No. 61/788,096, filed on Mar. 15, 2013.

(51) Int. Cl. G06Q 40/04; G06Q 50/06

(52) U.S. Cl. CPC G06Q 40/04; G06Q 50/06
USPC 705/37

(57) ABSTRACT

Methods and systems for interacting with volumetric position analysis by means of graphical, tabular, and summary tools are disclosed. The tools aid users to quickly understand information about a portfolio of trades, and to quickly identify positions that may need to be hedged with financial and/or physical instruments and/or commodities.

### CROSS-REFERENCE TO RELATED APPLICATIONS

This application claims priority to U.S. provisional application No. 61/788,003, filed Mar. 15, 2013 and U.S. Provisional Application No. 61/788,096, also filed on Mar. 15, 2013, the contents which applications are entirely incorporated by reference herein.

### TECHNICAL FIELD

The present disclosure relates generally to a system that supports the buying and selling of standardized or over-the-counter financial instruments and/or physical contracts and/or commodities. In particular it relates to a means for displaying the results of volumetric position calculations in visually useful manner over a relevant range.

### BACKGROUND

Financial instruments, such as futures and swaps, and physical contracts, such as forwards, are commonly used to help people and organizations mitigate various risks. These risks can include, but are not limited to, the risk that the seller of a commodity will default, and the risk that the price of a commodity will increase drastically just before a buyer needs the commodity. Companies commonly engage in the buying or selling of financial instruments or physical contracts (herein referred to as “trades”), many times throughout the course of a year. Some companies have one active (i.e., not yet completed contract) trade at any given time, and some companies have thousands, or even tens of thousands. Energy companies purchase electrical power from producers for delivery at a later time according to agreed schedules. Purchased power does not always coincide with the amount of power that an energy company anticipates will be required by consumers. The extent to which anticipated demand for power exceeds purchased supply is known as an “unhedged” position.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of the non-limiting embodiments presented herein.

FIG. 1 illustrates an example method of presenting volumetric position analysis for a portfolio of commodities;

FIG. 2 is a graphical representation of a company's volumetric position with regard to native positions and trades;

FIG. 3 illustrates a tabular representation of the same information as FIG. 2;

FIG. 4 is a view of native positions, data required to compare volumetric positions (once it's entered into the system);

FIG. 5 is another view of data required to compare volumetric positions (before it's entered into the system);

FIG. 6 is a summary view of a company's volumetric position with regard to native positions and trades, for an entire portfolio; and

FIG. 7 illustrates an example embodiment of a system 700 for analyzing volumetric position within this disclosure.

### DETAILED DESCRIPTION

In order to, among other things, determine the specifics of the trades that would beneficial to a company, a company might want to know its “native position,” or how much of a specific commodity it believes it will need during some future period, and its inventory of that commodity over the same period, (its “trade position”)—in other words, the impact of the trades it has made. Comparison of these values can yield useful information for making important decisions, such as for example, whether additional quantities of a specific commodity should be purchased (or sold), or whether derivatives relating to such commodities are warranted. For example, if analysis indicates a possible shortfall in a needed commodity, calls could be purchased covering the period of the anticipated shortfall.

Detailed descriptions of embodiments of the present disclosure are disclosed herein, however, it is to be understood that the disclosed embodiments are merely exemplary of the method that may be embodied in various and alternative forms. While the embodiments herein relate to energy and power commodities, it will be understood that the principles discussed herein can be practiced with regard to other commodities and with regard to financial instruments generally. The figures are not necessarily to scale. Some features may be exaggerated or minimized to show details of particular components. Therefore, specific structural and functional details disclosed herein are not to be interpreted as limiting, but merely as a basis for the claims and as a representative basis for teaching one skilled in the art to variously employ the present method.

Throughout this disclosure, the following definitions apply:

“Volumetric position” (also known as “trade position”) includes, but is not limited to, the amount of securities or commodities held by a person, firm, or institution. Volumetric position (or trade positions) includes the amount of a commodity purchased for delivery at a specified time, place, and/or date.

“Native position” includes, but is not limited to the amount of securities or commodities which a person, firm, or institution, anticipates will have to be delivered by the person, firm or institution and/or which the person, firm or institution is contractually obligated to deliver.

“Coupled” means joined immediately and/or indirectly, and means in signal communication.

Organizations commonly view their volumetric positions in the form of a table, in which each type of wholesale contract, and the amount of each commodity they have bought, is displayed alongside their native position in a corresponding commodity. It can be difficult to glean important information about the amount of energy commodities that need to be bought or sold by a company, simply by consulting such a table. Presented within at least one embodiment within this disclosure is a means to interact with volumetric position analysis in a way that will produce more meaningful and useful information.

At least one embodiment within this disclosure is a method of presenting volumetric position analysis for a portfolio of commodities. The method can include: receiving at least one input corresponding to a selection of a relevant date range; receiving information corresponding to a trade position series with respect to a commodity during the selected range; receiving information corresponding to a native position series with respect to the commodity during the selected range; and rendering the trade position series and the native position series in a single graph.

In at least one embodiment within this disclosure, the commodity referenced above can be electrical power. In at least one embodiment within this disclosure, a trade position series can correspond to electrical power purchased for delivery during the relevant date range. In at least one embodiment within this disclosure, the native position series can correspond to electrical power anticipated to be demanded by a firm's consumers during the relevant date range. In at least one embodiment within this disclosure, the native position series can correspond to electrical power contractually promised to consumers during the relevant date range.

At least one embodiment is a method of presenting a volumetric position analysis for a portfolio of commodities trades and hedging needs, in graphical, tabular, and summarized form, so as to draw attention to the important information inherent in the analysis. The method can include entering individual trades which are representative of a position with respect to a commodity. The method can further include calculating contents of individual trades with respect to the commodity to determine at least one volume of trades for the commodity during specific intervals. The method can further include displaying the calculated contents in a graphical, a tabular, and a summarized form, for example.

In at least one embodiment within this disclosure a method can also include presenting a graph composed of at least a first series and a second series. The first series can include a representation of a portfolio of physical commodities bought and/or sold in a relevant period. The second series can a representation of a native position of hedging needs. In at least one embodiment within this disclosure, the first series can be overlaid on the second series or the second series can be overlaid on the first series. Comparison of the overlaid series can serve as a useful visual tool in assessing the overall position of a company with regard to a given commodity.

In at least one embodiment within this disclosure pertains to a graph displaying more information than can be easily consumed by a user and intelligently averages hourly data by groups of days, including weekdays, weekends, and North American Electric Reliability Corporation (NERC) holidays.

In at least one embodiment of this disclosure, the relevant period discussed above can a twelve-hour period or a twenty-four hour period. These period lengths are only examples; other periods are possible within this disclosure.

In at least one embodiment within this disclosure, a device can be configured to render a table that displays the result of volumetric position calculations for all or some trades in a portfolio.

In at least one embodiment within this disclosure, a method of rendering volumetric information can include displaying a summary view that is visible throughout a system showing the results of volumetric position calculations for an entire portfolio, individual trades, or other sub-sections of a portfolio.

At least one embodiment within this disclosure pertains to a method for analyzing native positions. The method can include, but is not limited to: uploading at least one spreadsheet template containing one or more native positions; determining the contents of the uploaded spreadsheet, to evaluate the volume being plotted at specific intervals; and displaying the results of the evaluation in graphical, tabular, and summarized form.

In at least one embodiment within this disclosure, a graph that displays native positions and trades in terms of the volumes they represent is provided. The component parts of this graph include a series for the volume represented by trades, and a series for the volume represented by a native position.

In at least one embodiment within this disclosure, the graph is shown or displayed near a table containing detailed information about each relevant period displayed and its associated volumes (otherwise known as “volumetric positions”, such as 3 MW for hour ending 0100 on Apr. 1, 2013).

In at least one embodiment within this disclosure, as the data relevant to the viewer may vary, filters can be provided to limit or summarize what is displayed. Filters can include, but are not limited to: a) dates for which volumes are to be displayed, b) locations for which volumes are displayed, c) filters to remove weekends, weekdays, or NERC holidays from the graph, and d) filters to average information displayed over the period that is selected.

In at least one embodiment within this disclosure, only summary information (for example, the amount of volume that has not been accounted for by trades, or the total volume of all trades in the portfolio) is displayed. This can be in the form of text that is displayed on the screen in a central location so as to draw attention to salient facts.

At least one embodiment within this disclosure is a system for analyzing volumetric position. The system can include a device housing a display. The system can further include a processor coupled to the display and coupled to a non-transitory computer readable medium storing instructions that when executed by the processor, cause the processor to: receive at least one input corresponding to a selection of a relevant date range; receive information corresponding to a trade position series with respect to a commodity during the selected range; receive information corresponding to a native position series with respect to the commodity during the selected range; and render, on the display, the trade position series and the native position series in a single graph.

In at least one embodiment of a system within this disclosure, the commodity discussed above can be electrical power and the trade position series corresponds to electrical power purchased for delivery during the relevant date range. The length of the relevant date range can be one month, or one year, or other suitable length of time.

In at least one embodiment of a system within this disclosure, the native position series discussed above can correspond to electrical power anticipated to be demanded by at least one consumer user during the relevant date range. In at least one embodiment within this disclosure, the native position series can correspond to electrical power contractually promised to at least one consumer during the relevant date range.

At least one embodiment within this disclosure is a system for presenting a volumetric position analysis for a portfolio of commodities trades and hedging needs, in graphical, tabular, and summarized form, so as to draw attention to the important information inherent in the analysis. Such a system can include: a display; a processor coupled to the display and coupled to a non-transitory computer readable medium storing instructions that when executed by the processor, cause the processor to: receive information corresponding to individual trades representative of a position with respect to a commodity; calculate the contents of individual trades with respect to the commodity to determine at least one volume of trades for the commodity during specific intervals; and display on the display, the calculated contents in a graphical, a tabular, and a summarized form.

In at least one embodiment within this disclosure, the non-transitory computer readable medium can also store instructions that when executed by the processor, cause the processor to: display on the display a graph composed of at least a first series and a second series, the first series including a representation of a portfolio of physical commodities bought and sold in a relevant period, the second series including a representation of a native position of hedging needs. The first series can be overlaid on the second series or the second series is overlaid on the first series on the display.

In at least one embodiment of a system within this disclosure, the non-transitory computer readable medium can further store instructions that when executed by the processor, cause the processor to display additional information including averages of hourly data organized by groups of days, including weekdays, weekends, and NERC holidays. In at least one embodiment within this disclosure, the non-transitory computer readable medium can also include instructions to control the display to display the results of the volumetric position calculations for all trades in a portfolio. The non-transitory memory can also include instructions to cause the display of a summary view that is visible throughout the system showing the result of volumetric position calculations for an entire portfolio, individual trades, or other sub-sections of a portfolio.

Referring to the figures, FIG. 1 illustrates an example method 100 of presenting volumetric position analysis for a portfolio of commodities. The method 100 begins at block 102, in which at least one input corresponding to a selection of a relevant date range is received, (for example a user might elect to conduct a volumetric position analysis for the next twelve month). Once a date range has been selected, the method 100 can proceed to block 104, in which information corresponding to a native position series with respect to a commodity during the selected range is received. For example a native position series could include information regarding all of the electrical power a company expects to be required to deliver during the next twelve months. The method 100 can then proceed to block 106, in which information corresponding to a trade position series with respect to the commodity during the selected range. For example, a trade position series could include information about all of the electrical power a company has purchased for delivery during the next twelve months. The method 100 can then proceed to block 108, in which the trade position series and the native position series are rendered or displayed in a single graph.

An example of such a volumetric position graph is illustrated in FIG. 2. As illustrated in FIG. 2, a user can select a date range for filtering position using a date selector 1. Also illustrated is an indicator 2, which can indicated that averaged numbers are being displayed, as when the date range is greater than what can be usefully shown in detail on a display screen. Also illustrated is a toggle indicated 3, which is selectable to enable a user to choose between weekday and weekend/NERC holiday positions. Also illustrated is a location selection tool 4, which can enable a user to select a location at which receipt of a commodity and delivery of a commodity will take place. FIG. 2 also illustrates plots corresponding a company's trade position 5 in a commodity (the amount it of the commodity it has purchased) and a company's native position 6 (the anticipated demand for the commodity, or the quantity of the commodity the company has agreed to provide to consumers). The series for the graph shows the relevant volumetric unit of measure 15 on the y-axis 7, and the date or time 8 for flow of the energy on the x-axis 20. Indicator 10 indicates the time at which the data was last updated. Also illustrated is a selectable icon or selectable text 9. Selection of 9 can cause the position data (5, 6) to be displayed in tabular format, such as illustrated in FIG. 3.

As further illustrated in FIG. 3, a tabular view 300 of a company's volumetric positions at each hour can be seen in the column headed “HE”, or Hour Ending, 3:00 AM. A column marked “unhedged” 4 shows the difference between the trades made and the native position, or load. The quantities under columns 302 correspond to anticipated quantities needed during the time blocks under the “HE” column 3. The quantities under the “load” column 304 correspond to quantities already purchased for delivery from a supplier during the time blocks under the “HE” column 3.

FIG. 4 illustrates an example graphical user interface (GUI) used to assist in calculating positions as disclosed herein. Calculation of positions requires a set of native positions as shown in FIG. 3, which are uploaded to the system using the Upload button 1 and summarized using the graphs 42. Indicators 46 indicate the locations to which the graphs 42 pertain. Also illustrated are graph-type indicators 45, 47 and 48 which indicate the type of graphs 42 that are being displayed in the GUI. An analysis drop down menu 49 is also shown, which can be used to display additional information. Also illustrated is a download template icon 44. Selection of the download template icon 44 can cause a spreadsheet like that illustrated in FIG. 5 to be displayed.

FIG. 5 is a spreadsheet 500 showing the trade positions (508′, 508″) for a commodity. The top value in column A indicates the location at which the commodity is expected to be delivered, in this case, “HB Houston,” or the ERCOT Houston Hub. The dates 504 in column A are the dates are the dates under consideration. The numbers at the tops of columns B, C, D, E and F correspond to time periods ending in the last 15 minutes from the preceding period, with the first period beginning at one 1:00 am. So for example, examination of the spreadsheet 500 reveals that for the period from 1:00 am to 1:15 am, the company in question holds can expect to receive 5000 mega-watts of power at HB Houston.

FIG. 6 illustrates a summary view 600 for a position analysis in which the total difference between “trade positions” and “loads” (native positions) for a company during a specific time period is shown. This can be for the upcoming month, as shown, or for the foreseeable future. Other parts of the position analysis can be summarized in this way (for example, the amount of 5×16 volume purchased at a specific location for the upcoming month). A position-type indicator 602 indicates that the value displayed 604 corresponds to an unhedged position (in other words the extent to which demand for electrical power exceeds the amount of power purchased). A location indicator 606 indicates that location for the unhedged position. In the example of FIG. 6, the position is for electrical power to be received by the company and delivered by the company at the “Houston Hub.” A date indicator 608 indicates the date for the position. In the example of FIG. 6, the period for the unhedged position is May 12, 2013.

FIG. 7 illustrates an example embodiment of a system 700 for analyzing volumetric position within this disclosure. The system 700 can include an electronic device 701 (such as for example, a personal computer) having a display 710. The device 701 can include a processor 704 which is coupled to the display 710 and which is coupled to a non-transitory computer readable medium 702 storing instructions that when executed by the processor 704, cause the processor to perform the following functions: a) receive from an external source such as the internet 708 or an input device such as a keyboard 706, at least one input corresponding to a selection of a relevant date range; b) receive from the external source (706, 708) information corresponding to a trade position series with respect to a commodity during the selected range; c) receive information from the external source (706, 708) corresponding to a native position series with respect to the commodity during the selected range; and d) render, on the display 710, the trade position series and the native position series in a single graph. The processor 704 can store received information and information pertaining to the rendered trade position series and native position series in a database 712 for subsequent retrieval and analysis.

The devices, systems and methods disclosed and claimed herein can be made and executed without undue experimentation in light of the present disclosure. While the device and methods of this disclosure have been described in terms of preferred embodiments, it will be apparent to those of skill in the art that variations may be applied to the device and methods and in the steps or in the sequence of steps of the methods described herein without departing from the concept and scope of this disclosure. All such similar substitutes and modifications apparent to those skilled in the art are deemed to be within the spirit, scope and concepts of the disclosure as set forth in the following claims.

What is claimed is:

1. A method of presenting volumetric position analysis for a portfolio of commodities, the method comprising:
receiving at least one input corresponding to a selection of a relevant date range;
receiving information corresponding to a trade position series with respect to a commodity during the selected range;
receiving information corresponding to a native position series with respect to the commodity during the selected range; and
rendering the trade position series and the native position series in a single graph.

2. The method of claim 1, wherein the commodity is electrical power and the trade position series corresponds to electrical power purchased for delivery during the relevant date range.

3. The method of claim 2, wherein the native position series corresponds to electrical power anticipated to be demanded by at least one consumer user during the relevant date range.

4. The method of claim 2, wherein the native position series corresponds to electrical power contractually purchased during the relevant date range.

5. The method of claim 1, wherein a length of the relevant date range is one month.

6. A method of presenting a volumetric position analysis for a portfolio of commodities trades and hedging needs, in graphical, tabular, and summarized form, so as to draw attention to the important information inherent in the analysis, the method comprising:
entering individual trades representative of a position with respect to a commodity;
calculating contents of individual trades with respect to the commodity to determine at least one volume of trades for the commodity during specific intervals; and
displaying the calculated contents in a graphical, a tabular, and a summarized form.

7. The method of claim 6, further comprising:
presenting a graph composed of at least a first series and a second series, the first series including a representation of a portfolio of physical commodities bought and sold in a relevant period, the second series including a representation of a native position of hedging needs,
wherein the first series is overlaid on the second series or the second series is overlaid on the first series.

8. The method of claim 7, further comprising displaying additional information including averages of hourly data organized by groups of days, including weekdays, weekends, and NERC holidays.

9. The method of claim 6, further comprising displaying the results of the volumetric position calculations for all trades in a portfolio.

10. The method of claim 6, further comprising:
displaying a summary view that is visible throughout the system shows the result of volumetric position calculations for an entire portfolio, individual trades, or other sub-sections of a portfolio.

11. A system for analyzing volumetric position, the system comprising:
a display;
a processor coupled to the display and coupled to a non-transitory computer readable medium storing instructions that when executed by the processor, cause the processor to:
receive at least one input corresponding to a selection of a relevant date range;
receive information corresponding to a trade position series with respect to a commodity during the selected range;
receive information corresponding to a native position series with respect to the commodity during the selected range; and
render, on the display, the trade position series and the native position series in a single graph.

12. The system of claim 11, wherein the commodity is electrical power and the trade position series corresponds to electrical power purchased for delivery during the relevant date range.

13. The system of claim 12, wherein the native position series corresponds to electrical power anticipated to be demanded by at least one consumer user during the relevant date range.

14. The system of claim 12, wherein the native position series corresponds to electrical power contractually promised to at least one consumer during the relevant date range.

15. The system of claim 11, wherein a length of the relevant date range is one month.

16. A system for presenting a volumetric position analysis for a portfolio of commodities trades and hedging needs, in graphical, tabular, and summarized form, so as to draw attention to the important information inherent in the analysis, the system comprising:
a display;
a processor coupled to the display and coupled to a non-transitory computer readable medium storing instructions that when executed by the processor, cause the processor to:
receive information corresponding to individual trades representative of a position with respect to a commodity;
calculate the contents of individual trades with respect to the commodity to determine at least one volume of trades for the commodity during specific intervals; and
display on the display, the calculated contents in a graphical, a tabular, and a summarized form.

17. The system of claim 16, the non-transitory computer readable medium further storing instructions that when executed by the processor, cause the processor to:
display on the display a graph composed of at least a first series and a second series, the first series including a representation of a portfolio of physical commodities bought and sold in a relevant period, the second series including a representation of a native position of hedging needs,
wherein the first series is overlaid on the second series or the second series is overlaid on the first series.

18. The system of claim 17, the non-transitory computer readable medium further storing instructions that when executed by the processor, cause the processor to:
display additional information including averages of hourly data organized by groups of days, including weekdays, weekends, and NERC holidays.

19. The system of claim 16, the non-transitory computer readable medium further storing instructions that when executed by the processor, cause the processor to:
display the results of the volumetric position calculations for all trades in a portfolio.

20. The system of claim 16, the non-transitory computer readable medium further storing instructions that when executed by the processor, cause the processor to:
display a summary view that is visible throughout the system showing the result of volumetric position calculations for an entire portfolio, individual trades, or other sub-sections of a portfolio.
